(19) United States
(12) Patent Application Publication
(10) Pub. No.: US 2015/0116625 A1
(43) Pub. Date: Apr. 30, 2015

(54) LIQUID CRYSTAL DISPLAY PANEL

(71) Applicant: SAMSUNG DISPLAY CO., LTD., Yongin-City (KR)

(72) Inventors: In-Jae Hwang, Suwon-si (KR); Meehye Jung, Suwon-si (KR)

(21) Appl. No.: 14/446,211

(22) Filed: Jul. 29, 2014

(30) Foreign Application Priority Data
Oct. 24, 2013 (KR) 10-2013-0127429

(51) Int. Cl. G02F 1/1362

(52) U.S. Cl. CPC G02F 1/136209; G02F 2203/30
USPC 349/57; 349/110

(57) ABSTRACT

A liquid crystal display panel curved along a first direction includes an array substrate including first and second dots respectively including a plurality of first and second pixel areas, a main black matrix area, a sub-black matrix, a plurality of first and second pixel electrodes; an opposite substrate facing and coupled to the array substrate; and a liquid crystal layer between the array and opposite substrates. Each of the first pixel electrodes defines a corresponding first pixel area of the first pixel areas, each of the second pixel electrodes defines a corresponding second pixel area of the second pixel areas, the first pixel electrodes each have a same pattern, the second pixel electrodes each have a same pattern different from that of the first pixel electrodes, and a width of the sub-black matrix area is less than a width of the main black matrix area.

### CROSS-REFERENCE TO RELATED APPLICATION

This patent application claims priority to and the benefit of Korean Patent Application No. 10-2013-0127429, filed on Oct. 24, 2013 in the Korean Intellectual Property Office, the content of which is hereby incorporated in its entirety by reference.

### BACKGROUND

1. Field

Aspects of embodiments of the present disclosure are directed toward a liquid crystal display panel.

2. Description of the Related Art

As a flat panel display, a liquid crystal display panel is used to display an image in various electronic equipment, such as a television set, a monitor, a notebook, a mobile phone, etc. The liquid crystal display panel applies an electric field to a liquid crystal layer between two substrates and controls an intensity of the electric field to adjust an amount of light passing through the liquid crystal layer, thereby displaying desired images.

In recent years, a curved liquid crystal display panel has been developed. The curved liquid crystal display panel includes a curved display area to provide a user with the image having an improved three-dimensional effect, immersiveness, and presence.

### SUMMARY

Aspects of embodiments of the present disclosure are directed toward a liquid crystal display panel capable of improving a display quality of an image displayed in a curved display area.

Embodiments of the inventive concept include a liquid crystal display panel, which is curved along a first direction, and includes an array substrate including a first dot including a plurality of first pixel areas, a second dot including a plurality of second pixel areas, a main black matrix area extending in a second direction crossing (e.g., substantially perpendicular to) the first direction and between the first dot and the second dot, a sub-black matrix area extending in the second direction between the first pixel areas and the second pixel areas, a plurality of first pixel electrodes, and a plurality of second pixel electrodes, an opposite substrate facing the array substrate and coupled to the array substrate, and a liquid crystal layer between the array substrate and the opposite substrate. Each of the first pixel electrodes defines a corresponding first pixel area of the first pixel areas, each of the second pixel electrodes defines a corresponding second pixel area of the second pixel areas, the first pixel electrodes each have a same pattern, the second pixel electrodes each have a same pattern different from that of the first pixel electrodes, and a width of the sub-black matrix area is less than a width of the main black matrix area.

The width of the main black matrix area may be greater than a reference value, and the width of the sub-black matrix area may be less than the reference value.

The reference value may be determined according to a curvature and a thickness of the liquid crystal display panel.

Each of the first and second pixel areas may include a green pixel area configured to display a green light, a red pixel area configured to display a red light, and a blue pixel area configured to display a blue light.

Each of the first and second pixel areas may include a plurality of domains arranged along the second direction, and at least two domains among the domains in each of the first and second pixel areas may have liquid crystal alignment directions different from each other.

The domains may be arranged in a matrix form including n rows by m columns in the first and second dots, the liquid crystal alignment directions of each of the domains in an n-th row in the first pixel areas are each the same, and the liquid crystal alignment directions of the domains in the n-th row in the second pixel areas are each the same.

The liquid crystal alignment directions of the domains in the n-th row of the first dot may be different from the that of the domains in the n-th row of the second dot.

The liquid crystal alignment directions of the domains in the n-th row of the first dot may be symmetrical to the liquid crystal alignment directions of the domains in the n-th row of the second dot with respect to the main black matrix area.

A portion of each of the first and second pixel electrodes may extend to define the domains.

The domains may include a first domain, a second domain, a third domain, and a fourth domain, which are arranged along the second direction in each of the first and second pixel areas, and each of the first and second pixel electrodes includes first branch portions at the first domain and extending along a direction inclined with respect to the first and second directions in a plan view, second branch portions at the second domain and extending along a direction inclined with respect to the first and second directions in a plan view, third branch portions at the third domain and extending along a direction inclined with respect to the first and second directions, and fourth branch portions at the fourth domain and extending along a direction inclined with respect to the first and second directions.

The first and second pixel electrodes may respectively include a first sub-pixel electrode and a second sub-pixel electrode, and the first and second sub-pixel electrodes may be respectively configured to receive different data signals.

The array substrate may further include a shielding electrode electrically insulated from the pixel electrode and arranged along the main and sub-black matrix areas, and the shielding electrode may be configured to control the liquid crystal layer to display a gray scale.

The opposite substrate may include a common electrode, and the shielding electrode may be configured to receive a voltage having a same voltage level as the voltage applied to the common electrode.

The array substrate may further include an insulating layer between the pixel electrode and the shielding electrode.

The liquid crystal layer may include liquid crystal molecules having a negative dielectric anisotropy.

The array substrate may further include a plurality of data lines extending in the second direction and a plurality of gate lines extending in the first direction, and the data lines may be arranged along the main and sub-black matrix areas.

The liquid crystal display panel may further include a light blocking layer that extends along the gate lines, covers the gate lines in a plan view, and includes a light blocking material.

The liquid crystal display panel may further include a light blocking layer that extends along the main and sub-black matrix areas, covers the main and sub-black matrix areas in a plan view, and includes a light blocking material.

According to the above and other aspects of embodiments of the present invention, although the mis-alignment occurs between the array substrate and the opposite substrate in the curved liquid crystal display panel, a defect in texture, which is caused by the mis-alignment of liquid crystal molecules, is prevented. Thus, the display quality of the liquid crystal display panel is improved. In addition, because the width of the sub-black matrix area is reduced, the aperture ratio of the pixel is increased.

### BRIEF DESCRIPTION OF THE DRAWINGS

The above and other features of the present disclosure will become more readily apparent by reference to the following detailed description when considered in conjunction with the accompanying drawings wherein:

FIG. 1A is a perspective view showing a liquid crystal display panel according to an example embodiment of the present disclosure;

FIG. 1B is a side view showing the liquid crystal display panel shown in FIG. 1A;

FIG. 2 is a plan view showing a pixel of the liquid crystal display panel according to an example embodiment of the present disclosure;

FIG. 3 is a cross-sectional view taken along a line I-I′ of FIG. 2;

FIG. 4 is a cross-sectional view taken along a line II-II′ of FIG. 2;

FIG. 5 is a plan view showing domains and liquid crystal alignment directions defined in the pixel shown in FIG. 2;

FIG. 6 is a cross-sectional view taken along a line III-III′ of FIG. 5;

FIG. 7 is a plan view showing first and second dots of a liquid crystal display panel according to an example embodiment of the present disclosure;

FIG. 8 is a plan view showing domains and liquid crystal alignment directions defined in the pixel shown in FIGS. 7; and

FIG. 9 is a cross-sectional view taken along a line IV-IV′ of FIG. 8.

### DETAILED DESCRIPTION

It will be understood that when an element or layer is referred to as being “on”, “connected to”, or “coupled to” another element or layer, it can be directly on, connected, or coupled to the other element or layer; or one or more intervening elements or layers may also be present. When an element is referred to as being “directly on,” “directly connected to”, or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present disclosure.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below”, “beneath”, or “under” other elements or features would then be oriented “above” or “over” the other elements or features. Thus, the exemplary term “below” may encompass both an orientation of above and below. The device may be otherwise oriented (rotated 90 degrees or at other orientations), and the spatially relative descriptors used herein interpreted accordingly.

The terminology used herein is for the purpose of describing particular embodiments only and is not intended to be limiting of the disclosure. As used herein, the singular forms, “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Further, the use of “may” when describing embodiments of the present invention refers to “one or more embodiments of the present invention.”

Hereinafter, the present disclosure will be explained in detail with reference to the accompanying drawings.

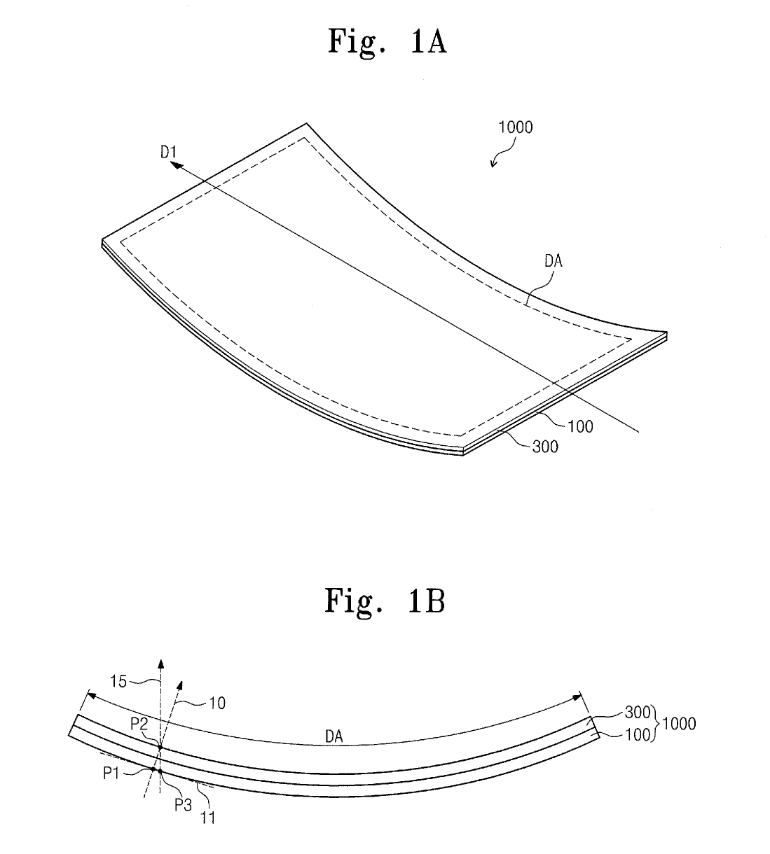

FIG. 1A is a perspective view showing a liquid crystal display panel according to an example embodiment of the present disclosure, and FIG. 1B is a side view showing the liquid crystal display panel shown in FIG. 1A.

Referring to FIGS. 1A and 1B, a liquid crystal display panel 1000 includes a display area DA at which an image is displayed and has a curved shape. Accordingly, the liquid crystal display panel 1000 may display the image having an improved three-dimensional effect, immersiveness, and presence using the display area DA having the curved shape.

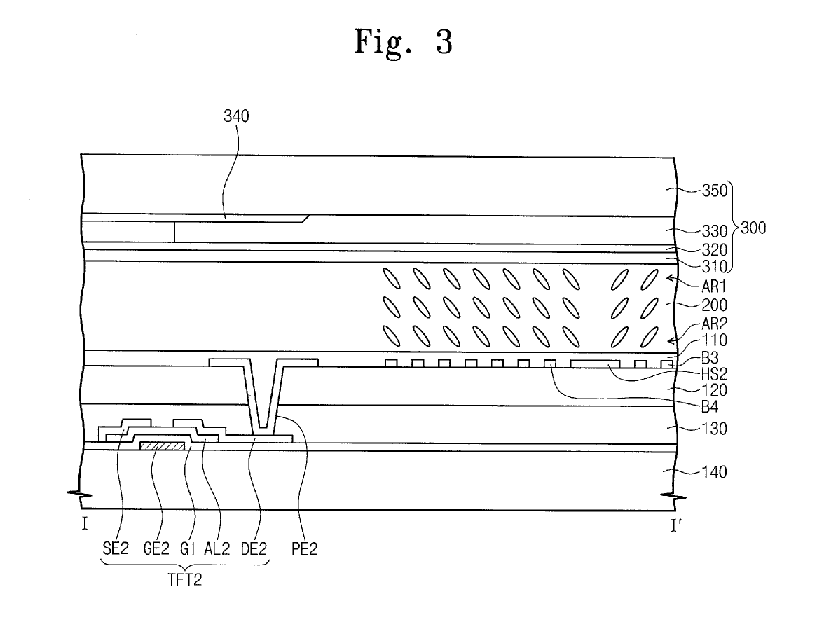

The liquid crystal display panel 1000 includes an array substrate 100, an opposite substrate 300, and a liquid crystal layer 200 (refer to FIG. 3). The opposite substrate 300 faces the array substrate 100 while being coupled to the array substrate 100, and the liquid crystal layer 200 is between the array substrate 100 and the opposite substrate 300.

The liquid crystal display panel 1000 includes a plurality of pixels arranged in a matrix form in the display area DA. Each pixel generates an image in response to a signal applied thereto.

The liquid crystal display panel 1000 is curved along a first direction D1 in relation to a plane surface. Accordingly, an entire or a portion of the array substrate 100 has the curved shape along the first direction D1, and the display area DA has the curved shape along first direction D1. In addition, the opposite substrate 300 may have the curved shape corresponding to that of the array substrate 100.

Here, a first point P1 is defined at a curved portion of the array substrate 100 at the side surface of the array substrate 100, a normal line 10 is defined with respect to an upper surface of the array substrate 100 (that is, the normal line 10 extends normal to the upper surface of the array substrate 100) to cross the first point P1, and a second point P2 is defined at the opposite substrate 300 to meet or intersect the normal line 10. In addition, a gaze line 15, which is substantially parallel to a user's view direction, is defined to cross the second point P2, and a third point P3 is defined at the array substrate 100 to meet or intersect the gaze line 15. In this case, because the array substrate 100 and the opposite substrate 300 have the curved shape, a position of the first point P1 may be different from that of the third point P3 at the array substrate 100.

As described above, a phenomenon in which the position of the first point

P1 does not match with that of the third point P3 is called a mis-alignment between the array substrate 100 and the opposite substrate 300. Hereinafter, a structure of the liquid crystal display panel 1000 which prevents a display quality of the image displayed in the display area DA of the liquid crystal display panel 1000 from being deteriorated due to the mis-alignment will be described.

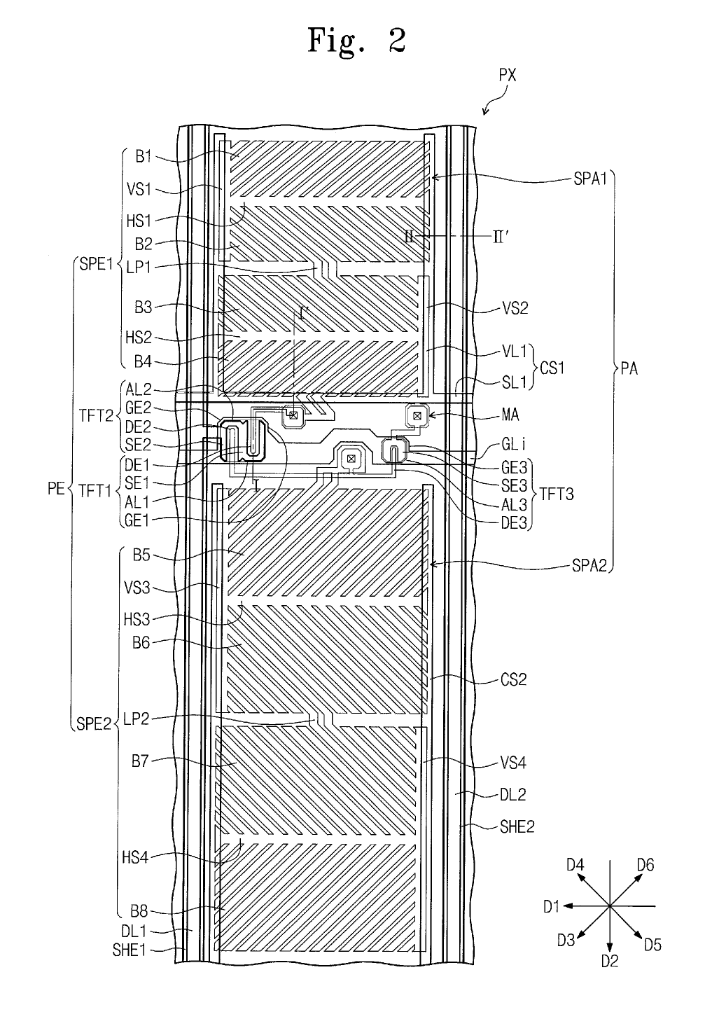

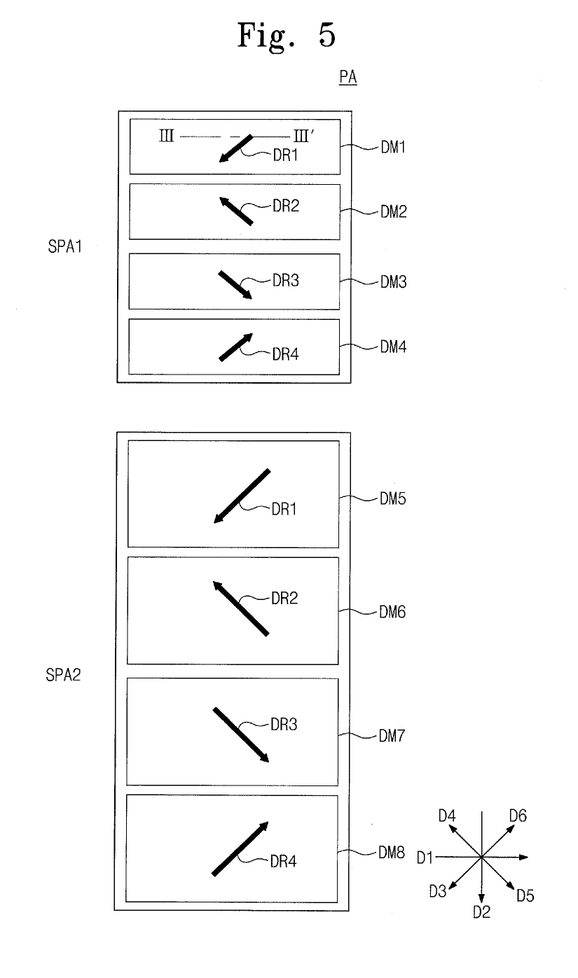

FIG. 2 is a plan view showing a pixel PX of the liquid crystal display panel according to an example embodiment of the present disclosure, FIG. 3 is a cross-sectional view taken along the line I-I′ of FIG. 2, and FIG. 5 is a plan view showing domains and liquid crystal alignment directions defined in the pixel shown in FIG. 2. Because the pixels have substantially the same or the same structure and function, only one pixel is shown in FIG. 2 and the other pixels are omitted. In addition, FIG. 2 primarily shows the structure of the array substrate 100, and FIG. 3 primarily shows the structure of the opposite substrate 300.

Referring to FIGS. 2, 3, and 5, the array substrate 100 includes a first base substrate 140, a gate line GL, a first data line DL1, a second data line DL2, a first thin film transistor TFT1, a second thin film transistor TFT2, a third thin film transistor TFT3, a pixel electrode PE, and a first alignment layer 110. The opposite substrate 300 includes a second alignment layer 310, a color filter 330, a common electrode 320, a light blocking layer 340, and a second base substrate 350.

The first base substrate 140 may be an insulating substrate having relatively high light transmittance and/or flexibility (e.g., a plastic substrate).

The gate line GL is disposed on the first base substrate 140 to transmit a gate signal to the first to third thin film transistors TFT1, TFT2, and TFT3. The gate line GL extends along the first direction D1 and is electrically coupled to (e.g., electrically connected to) the first to third thin film transistors TFT1, TFT2, and TFT3.

The first and second data lines DL1 and DL2 are insulated from the gate line GL and disposed on the first base substrate 140. The first and second data lines DL1 and DL2 are spaced from (e.g., spaced apart from) each other along the first direction D1 and extend along a second direction D2 that crosses (e.g., is substantially perpendicular to) the first direction Dl. The first data line DL1 transmits a data signal to the first and second thin film transistors TFT1 and TFT2.

The pixel PX includes a pixel area PA defined by the first data line DL1, the second data line DL2, and an intermediate area MA. The pixel area PA includes a first sub-pixel area SPA1 and a second sub-pixel area SPA2. The intermediate area MA is disposed between the first sub-pixel area SPA1 and the second sub-pixel area SPA2. In the present example embodiment, the first sub-pixel area SPA1, the second sub-pixel area SPA2, and the intermediate area MA are arranged (e.g., sequentially arranged) along the second direction D2.

In this case, the pixel electrode PE includes a first sub-pixel electrode SPE1 at the first sub-pixel area SPA1 and a second sub-pixel electrode SPE2 at the second sub-pixel area SPA2. The first sub-pixel area SPA1 includes a first domain

DM1, a second domain DM2, a third domain DM3, and a fourth domain DM4, and the second sub-pixel area SPA2 includes a fifth domain DM5, a sixth domain DM6, a seventh domain DM7, and an eighth domain DM8.

The pixel PX includes a first storage electrode CS1 and a second storage electrode CS2. The first and second storage electrodes CS1 and CS2 are respectively overlapped with the first sub-pixel electrode SPE1 and the second sub-pixel electrode SPE2 to form a first capacitor and a second capacitor. The first and second storage electrodes CS1 and CS2 receive a storage voltage.

The first storage electrode CS1 includes a first storage line SL1 extending along the first direction D1 and a first sub-storage line VL1 extending along the second direction D2 from the first storage line SL1. At least a portion of the first storage line SL1 is overlapped with a lower edge of the first sub-pixel electrode SPE1 when viewed in a plan view. At least a portion of the first sub-storage line VL1 is overlapped with left and/or right edges of the first sub-pixel electrode SPE1 when viewed in a plan view.

The second storage electrode CS2 extends along the second direction D2 from a second storage line, which is at a pixel arranged adjacent to a lower portion of the pixel PX, and at least a portion of the second storage electrode CS2 is overlapped with left and/or right edges of the second sub-pixel electrode SPE2 when viewed in a plan view.

The gate line GL and the first to third thin film transistors TFT1 to TFT3 are at the intermediate area MA.

The first thin film transistor TFT1 is electrically coupled to (e.g., electrically connected to) the gate line GL, the first data line DL1, and the first sub-pixel electrode SPE1. Accordingly, when the first thin film transistor TFT1 is turned on in response to the gate signal, the data signal is applied to the first sub-pixel electrode SPE1.

The first thin film transistor TFT1 includes a first gate electrode GE1, a first semiconductor layer AL1, a first source electrode SE1, and a first drain electrode DE1. The first gate electrode GE1 is branched from the gate line GL, the first semiconductor layer AL1 is disposed on the first gate electrode GE1, and a gate insulating layer GI is between the first semiconductor layer AL1 and the first gate electrode GE1. The first source electrode SE1 is branched from the first data line DL1 to make contact with the first semiconductor layer AL1, and the first drain electrode DE1 is spaced from (e.g., spaced apart from) the first source electrode SE1 to make contact with the first semiconductor layer AL1. The first drain electrode DE1 is electrically coupled to (e.g., electrically connected to) a first connection electrode branched from the first sub-pixel electrode SPE1 through a contact opening (e.g., a contact hole).

The second thin film transistor TFT2 and the third thin film transistor TFT3 apply a sub-data signal, which is different from the data signal, to the second sub-pixel electrode SPE2. The sub-data signal is determined based on the data signal.

The second thin film transistor TFT2 includes a second gate electrode GE2, a second semiconductor layer AL2, a second source electrode SE2, and a second drain electrode DE2. The second gate electrode GE2 is branched from the gate line GL, the second semiconductor layer AL2 is disposed on the second gate electrode GE2, and the gate insulating layer GI is between the second semiconductor layer AL2 and the second gate electrode GE2. The second source electrode SE2 is branched from the first data line DL1 to make contact with the second semiconductor layer AL2, and the second drain electrode DE2 is spaced from (e.g., spaced apart from) the second source electrode SE2 to make contact with the second semiconductor layer AL2. The second drain electrode DE2 is electrically coupled to (e.g., electrically connected to) a second connection electrode branched from the second sub-pixel electrode SPE2 through a contact opening (e.g., a contact hole).

The third thin film transistor TFT3 includes a third gate electrode GE3, a third semiconductor layer AL3, a third source electrode SE3, and a third drain electrode DE3. The third gate electrode GE3 is branched from the gate line GL, the third semiconductor layer AL3 is disposed on the third gate electrode GE3, and the gate insulating layer GI is between the third semiconductor layer AL3 and the third gate electrode GE3. The third drain electrode DE3 extends from the second drain electrode DE2 to make contact with the third semiconductor layer AL3. The third source electrode SE3 is spaced from (e.g., spaced apart from) the third drain electrode DE3 to make contact with the first semiconductor layer AL3. The third source electrode SE3 is electrically coupled to (e.g., electrically connected to) the first storage line SL1 through a contact opening (e.g., a contact hole).

The first thin film transistor TFT1 may have the same size as that of the second thin film transistor TFT2. The third thin film transistor TFT3 may have a size smaller than that of the second thin film transistor TFT2.

The second and third thin film transistors TFT2 and TFT3 are turned on in response to the gate signal applied through the gate line GL. The turned-on second thin film transistor TFT2 applies the data signal received through the first data line DL1 to the second sub-pixel electrode SPE2. The turned-on third thin film transistor TFT3 applies the storage voltage received through the first storage line SL1 to the second sub-pixel electrode SPE2 to lower a voltage level of the data signal.

For example, the second sub-pixel electrode SPE2 receives a voltage having a voltage level divided by the resistance value in the second and third thin film transistors TFT2 and TFT3 when the second and third thin film transistors TFT2 and TFT3 are turned on. Here, the voltage applied to the second sub-pixel electrode SPE2 is defined as a voltage of the sub-data signal. The voltage of the sub-data signal has an intermediate voltage value between the data voltage and the storage voltage.

According to the above description, the first to third thin film transistors TFT1 to TFT3 are turned on in response to the gate signal. Then, the data signal is applied to the first sub-pixel electrode SPE1 through the first thin film transistor

TFT1, and the sub-data signal is applied to the second sub-pixel electrode SPE2 through the second thin film transistor TFT2. Therefore, the first and second sub-pixel electrodes SPE1 and SPE2 are driven by data signals that are different from each other, and thus, different gray scales are displayed in the first and second sub-pixel areas SPA1 and SPA2.

Here, the array substrate 100 includes a first insulating layer 130, a second insulating layer 120, and the first alignment layer 110. The first insulating layer 130 is over (e.g., covers) the second thin film transistor TFT2, and the second insulating layer 120 is disposed on the first insulating layer 130. The contact opening (e.g., the contact hole) is formed through the first and second insulating layers 130 and 120 to expose the second drain electrode DE2.

The first sub-pixel electrode SPE1 is disposed on the second insulating layer 120, and the first sub-pixel electrode SPE1 makes contact with the second drain electrode DE2 through the contact opening.

The liquid crystal layer 200 is between the array substrate 100 and the opposite substrate 300 and controls an amount of light passing through the liquid crystal layer 200. The liquid crystal layer 200 includes a plurality of liquid crystal molecules having a dielectric anisotropy. The liquid crystal molecules have a negative dielectric anisotropy, and thus, a long axis of the liquid crystal molecules may be arranged substantially perpendicular to an electric field applied thereto, but it should not be limited thereto or thereby. That is, the liquid crystal molecules may have a positive dielectric anisotropy, and thus the long axis of the liquid crystal molecules may be arranged substantially parallel to the electric field applied thereto. The liquid crystal molecules are aligned vertically with respect to the array substrate 100 and the opposite substrate 300, and are between the array substrate 100 and the opposite substrate 300. In addition, according to another embodiment, the liquid crystal molecules may be aligned horizontally with respect to the array substrate 100 and the opposite substrate 300.

When an electric field is applied between the array substrate 100 and the opposite substrate 300, the liquid crystal molecules of the liquid crystal layer 200 are realigned along a specific direction, and a polarization of light passing through the realigned liquid crystal molecules is changed due to an optical anisotropy of the realigned liquid crystal molecules. Thus, the light transmits through or is blocked by a polarization plate disposed on the array substrate 100 and/or the opposite substrate 300.

The term “realign” used herein means that the liquid crystal molecules are rotated to be substantially parallel to or substantially perpendicular to the array substrate 100 or the opposite substrate 300.

The first alignment layer 110 is disposed on the pixel electrode PE to make contact with the liquid crystal layer 200. When no electric field is applied between the array substrate 100 and the opposite substrate 300, the first alignment layer 110 aligns the liquid crystal molecules of the liquid crystal layer 200 such that the liquid crystal molecules are inclined with respect to the first alignment layer 110.

The opposite substrate 300 includes the second base substrate 350, the color filter 330, the light blocking layer 340, the common electrode 320, and the second alignment layer 310. The second base substrate 350 may be an insulating substrate having high light transmittance and/or flexibility (e.g., a plastic substrate).

The common electrode 320 is disposed on or under the second base substrate 350 to form the electric field applied to the liquid crystal layer 200 in cooperation with the pixel electrode PE. The light blocking layer 340 may be disposed on the second base substrate 350 to correspond to the gate line GL, the first thin film transistor TFT1, and the second thin film transistor TFT2, and the light blocking layer 340 blocks the light. In addition, the color filter 330 is disposed on the second base substrate 350 to filter or change the light passing through the liquid crystal layer into a color light (e.g., a specific color light).

In the present example embodiment, the light blocking layer 340 and the color filter 330 are disposed on the second base substrate 350, however they should not be limited thereto or thereby. For instance, according to another embodiment, at least one of the light blocking layer 340 and the color filter 330 may be disposed on the first base substrate 140.

The first sub-pixel electrode SPE1 includes a first horizontal trunk portion HS1, a second horizontal trunk portion HS2, a first vertical trunk portion VS1, a second vertical trunk portion VS2, and first, second, third, and fourth branch portions B1, B2, B3, and B4.

The first vertical trunk portion VS1 is coupled to (e.g., connected to) the first horizontal trunk portion HS1, edges of the first branch portions B1, and edges of the second branch portions B2, and the second vertical trunk portion VS2 is coupled to (e.g., connected to) the second horizontal trunk portion HS2, edges of the third branch portions B3, and edges of the fourth branch portions B4. The first and second vertical trunk portions VS1 and VS2 extend along the second direction D2.

The first horizontal trunk portion HS1 is coupled to (e.g., connected to) the first vertical trunk portion VS1, the edges of the first branch portions B1, and the edges of the second branch portions B2. The first horizontal trunk portion HS1 extends along the first direction D1 and is branched from a center portion of the first vertical trunk portion VS1. The first branch portions B1 have a shape substantially symmetrical to that of the second branch portions B2 with respect to the first horizontal trunk portion HS1, and the first horizontal trunk portion HS1 is disposed between the first domain DM1 and the second domain DM2.

The second horizontal trunk portion HS2 is coupled to (e.g., connected to) the second vertical trunk portion VS2, the edges of the third branch portions B3, and the edges of the fourth branch portions B4. In the present example embodiment, the second horizontal trunk portion HS2 extends along the first direction D1 and is branched from a center portion of the second vertical trunk portion VS2. The third branch portions B3 have a shape substantially symmetrical to that of the fourth branch portions B4, and the second horizontal trunk portion HS2 is disposed between the third domain DM3 and the fourth domain DM4.

The first branch portions B1 are at the first domain DM1, a portion of the first branch portions B1 is branched from the first horizontal trunk portion HS1, and the other portion of the first branch portions B1 is branched from the first vertical trunk portion VS1. In addition, the first branch portions B1 extend along a third direction D3 inclined with respect to the first and second directions D1 and D2 in a plan view and are arranged to be spaced from (e.g., spaced apart from) each other.

The second branch portions B2 are at the second domain DM2, a portion of the second branch portions B2 is branched from the first horizontal trunk portion HS1, and the other portion of the second branch portions B2 is branched from the first vertical trunk portion VS1. In addition, the second branch portions B2 extend along a fourth direction D4 inclined with respect to the first and second directions D1 and D2 in a plan view and are arranged to be spaced from (e.g., spaced apart from) each other.

When viewed in a plan view, the fourth direction D4 may cross the third direction D3. For instance, the third and fourth directions D3 and D4 may be substantially perpendicular to each other when viewed in a plan view, and each of the third and fourth directions D3 and D4 forms an angle of about 45 degrees with respect to the first direction D1 or the second direction D2.

The third branch portions B3 are at the third domain DM3, a portion of the third branch portions B3 is branched from the second horizontal trunk portion HS2, and the other portion of the third branch portions B3 is branched from the second vertical trunk portion VS2. In addition, the third branch portions B3 extend along a fifth direction D5 inclined with respect to the first and second directions D1 and D2 in a plan view and are arranged to be spaced from (e.g., spaced apart from) each other.

The fourth branch portions B4 are at the fourth domain DM4, a portion of the fourth branch portions B4 is branched from the second horizontal trunk portion HS2, and the other portion of the fourth branch portions B4 is branched from the second vertical trunk portion VS2. In addition, the fourth branch portions B4 extend along a sixth direction D6 inclined with respect to the first and second directions D1 and D2 in a plan view and are arranged to be spaced from (e.g., spaced apart from) each other.

When viewed in a plan view, the sixth direction D6 may cross the fifth direction D5. For instance, the fifth and sixth directions D5 and D6 may be substantially perpendicular to each other when viewed in a plan view, and each of the fifth and sixth directions D5 and D6 forms an angle of about 45 degrees with respect to the first direction D1 or the second direction D2.

The second sub-pixel electrode SPE2 may have a size different from that of the first sub-pixel electrode SPE1, but the second sub-pixel electrode SPE2 may have a shape similar to that of the first sub-pixel electrode SPE1.

The second sub-pixel electrode SPE2 includes a third horizontal trunk portion HS3, a fourth horizontal trunk portion HS4, a third vertical trunk portion VS3, a fourth vertical trunk portion VS4, and fifth, sixth, seventh, and eighth branch portions B5, B6, B7, and B8.

The third vertical trunk portion VS3 extends along the second direction D2 and is coupled to (e.g., connected to) the third horizontal trunk portion HS3, edges of the fifth branch portions B5, and edges of the sixth branch portions B6. The fourth vertical trunk portion VS4 extends along the second direction D2 and is coupled to (e.g., connected to) the fourth horizontal trunk portion HS4, edges of the seventh branch portions B7, and edges of the eighth branch portions B8.

The third horizontal trunk portion HS3 is branched from the third vertical trunk portion VS3 and extends along the first direction D1, and the fourth horizontal trunk portion HS4 is branched from the fourth vertical trunk portion VS4 and extends along the first direction D1. In the present example embodiment, the third horizontal trunk portion HS3 is branched from a center portion of the third vertical trunk portion VS3, and the fourth horizontal trunk portion HS4 is branched from a center portion of the fourth vertical trunk portion VS4.

The fifth branch portions B5 are at the fifth domain DM5, a portion of the fifth branch portions B5 is branched from the third horizontal trunk portion HS3, and the other portion of the fifth branch portions B5 is branched from the third vertical trunk portion VS3. The fifth branch portions B5 extend along the third direction D3 in a plan view and are arranged to be spaced from (e.g., spaced apart from) each other.

The sixth branch portions B6 are at the sixth domain DM6, a portion of the sixth branch portions B6 is branched from the third horizontal trunk portion HS3, and the other portion of the sixth branch portions B6 is branched from the third vertical trunk portion VS3. The sixth branch portions B6 extend along the fourth direction D4 and are arranged to be spaced from (e.g., spaced apart from) each other.

The seventh branch portions B7 are at the seventh domain DM7, a portion of the seventh branch portions B7 is branched from the fourth horizontal trunk portion HS4, and the other portion of the seventh branch portions B7 is branched from the fourth vertical trunk portion VS4. The seventh branch portions B7 extend along the fifth direction D5 and are arranged to be spaced from (e.g., spaced apart from) each other.

The eighth branch portions B8 are at the eighth domain DM8, a portion of the eighth branch portions B8 is branched from the fourth horizontal trunk portion HS4, and the other portion of the eighth branch portions B8 is branched from the fourth vertical trunk portion VS4. The eighth branch portions B8 extends along the sixth direction D6 and are arranged to be spaced from (e.g., spaced apart from) each other.

The first sub-pixel electrode SPE1 further includes a first domain connection part LP1, and the second sub-pixel electrode SPE2 further includes a second domain connection part LP2.

The first domain connection part LP1 is disposed between the second domain DM2 and the third domain DM3 to electrically couple (e.g., electrically connect) the second and third branch portions B2 and B3, and the second domain connection part LP2 is disposed between the sixth domain DM6 and the seventh domain DM7 to electrically couple (e.g., electrically connect) the sixth and seventh branch portions B6 and B7.

The first domain connection part LP1 is disposed at a center of a boundary area between the second and third domains DM2 and DM3, and the second domain connection part LP2 is disposed at a center of a boundary area between the sixth and seventh domains DM6 and DM7.

When the area at which the liquid crystal molecules are aligned by the first branch portions B1 is referred to as the first domain DM1, a first liquid crystal alignment direction DR1 in the first domain DM1 corresponds to the third direction D3. When the area at which the liquid crystal molecules are aligned by the second branch portions B2 is referred to as the second domain DM2, a second liquid crystal alignment direction DR2 in the second domain DM2 corresponds to the fourth direction D4.

Similarly, a third liquid crystal alignment direction DR3 in the third domain DM3 corresponds to the fifth direction D5, and a fourth liquid crystal alignment direction DR4 in the fourth domain DM4 corresponds to the sixth direction D6.

As described above, the first to fourth domains DM1 to DM4, arranged (e.g., sequentially arranged) along the second direction D2, are formed at the first sub-pixel area SPA1, and the liquid crystal alignment directions are different from each other at the first to fourth domains DM1 to DM4 (e.g., the liquid crystal alignment directions are different from each other at each of the first to fourth domains DM1 to DM4). Accordingly, a viewing angle with respect to the first sub-pixel area SPA1 may be expanded.

In addition, the fifth to eighth domains DM5 to DM8, arranged (e.g., sequentially arranged) along the second direction D2, are formed at the second sub-pixel area SPA2, and the liquid crystal alignment directions are different from each other in the fifth to eighth domains DM5 to DM8 (e.g., the liquid crystal alignment directions are different from each other at each of the fifth to eighth domains DM5 to DM8). Accordingly, a viewing angle with respect to the second sub-pixel area SPA2 may be expanded.

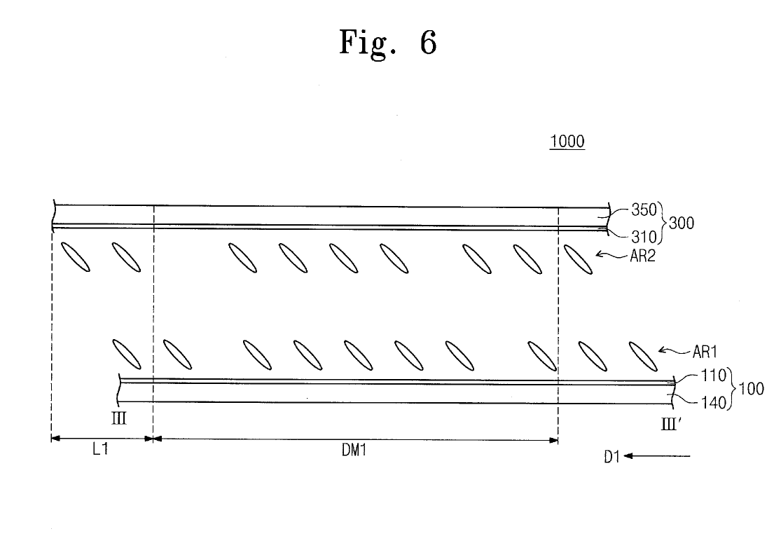

Hereinafter, effects obtained when the first to eighth domains DM1 to EM8 having the above described features are defined in the first and second sub-pixel areas SPA1 and SPA2 will be described in detail with reference to FIG. 6.

FIG. 6 is a cross-sectional view taken along the line III-III′ of FIG. 5. For the convenience of explanation, only some elements included in the liquid crystal display panel 1000 are illustrated, and thus the other elements may be omitted in the detailed description of FIG. 6.

Referring to FIG. 6, the mis-alignment occurs between the array substrate 100 and the opposite substrate 300 because the liquid crystal display panel 1000 is curved along the first direction D1. In this case, the first array substrate 100 may be mis-aligned from the opposite substrate 300 by a first length L1 along the first direction D1.

However, in the present example embodiment, because the first to eighth domains DM1 to DM8 are arranged along the second direction D2 that crosses (e.g., is substantially perpendicular to) the first direction D1, a defect in texture, which is caused by the liquid crystal mis-alignment, may be prevented from occurring.

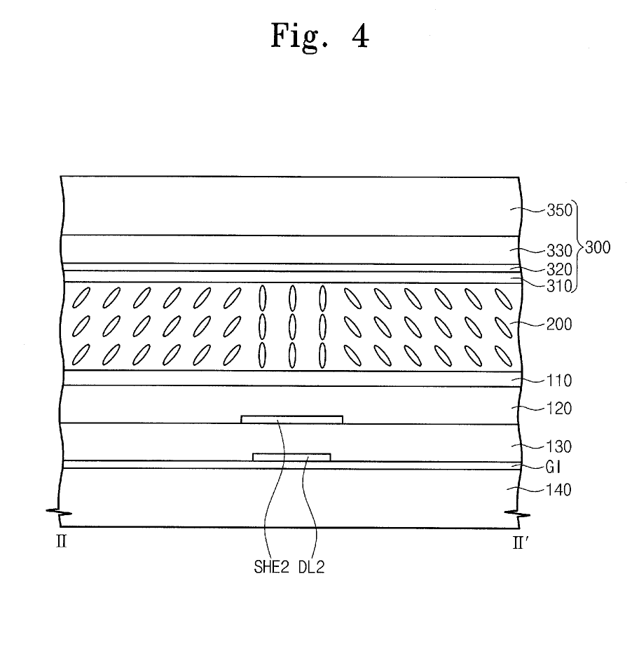

For example, when an area in which the liquid crystal molecules are aligned by the first alignment layer 110 disposed in the array substrate 100 is referred to as a lower alignment area AR1, and an area in which the liquid crystal molecules are aligned by the second alignment layer 310 disposed in the opposite substrate 300 is referred to as an upper alignment area AR2, the liquid crystal alignment direction in each of the lower and upper alignment areas AR1 and AR2 is the same as the first alignment direction DR1 (refer to FIG. 4). In this case, even though the opposite substrate 300 is shifted along the first direction D1 and the position of the lower alignment area AR1 does not match with the position of the upper alignment area AR2, the lower alignment area AR1 and the upper alignment area AR2, having the same liquid crystal alignment direction, are overlapped with each other in the first domain DM1. That is, the lower alignment area AR1 is not overlapped with an other upper alignment area having a different alignment direction in the first domain DM1.

Accordingly, in the present example embodiment, the mis-alignment caused by the overlapping of the upper alignment area and the lower alignment area, which are aligned in directions different from each other, is prevented, and thus, a defect in texture and a deterioration in transmittance in each domain caused by the mis-alignment are prevented.

FIG. 4 is a cross-sectional view taken along the line II-II′ of FIG. 2.

Referring to FIGS. 2 and 4, the array substrate 100 includes a first shielding electrode SHE1 and a second shielding electrode SHE2. The first and second shielding electrodes SHE1 and SHE2 block the light provided from or emitted by a backlight assembly. For example, the first and second shielding electrodes SHE1 and SHE2 extend along the second direction D2, are electrically insulated from the first and second data lines DL1 and DL2, and are respectively overlapped with the first and second data lines DL1 and DL2. The first and second shielding electrodes SHE1 and SHE2 receive a voltage having substantially the same or the same level as the voltage applied to the common electrode CE.

Thus, no electric field is formed between the common electrode CE and the first and second shielding electrodes SHE1 and SHE2. In this case, because the liquid crystal molecules on the first and second shielding electrodes SHE1 and SHE2 have the negative dielectric anisotropy, the liquid crystal molecules are realigned to be perpendicular to the array substrate 100. Therefore, a polarization of the light incident to the liquid crystal molecules, which are vertically aligned, is not changed and the light is blocked by the polarization plate of the opposite substrate 300.

However, the first and second shielding electrodes SHE1 and SHE2 may be changed in various ways. For instance, the first shielding electrode SHE1 may be a main shielding electrode, and the second shielding electrode SHE2 may be a sub-shielding electrode having a width narrower than that of the main shielding electrode. Detailed descriptions of the above will be further described later.

As described above, although the mis-alignment occurs between the array substrate 100 and the opposite substrate 300 due to the curved shape of the liquid crystal display panel 1000 along the first direction D1, no electric field is formed between the first and second data lines DL1 and DL2 and the first and second shielding electrodes SHE1 and SHE2, respectively, and thus, a vertical dark line may be prevented from occurring in the pixel area PA.

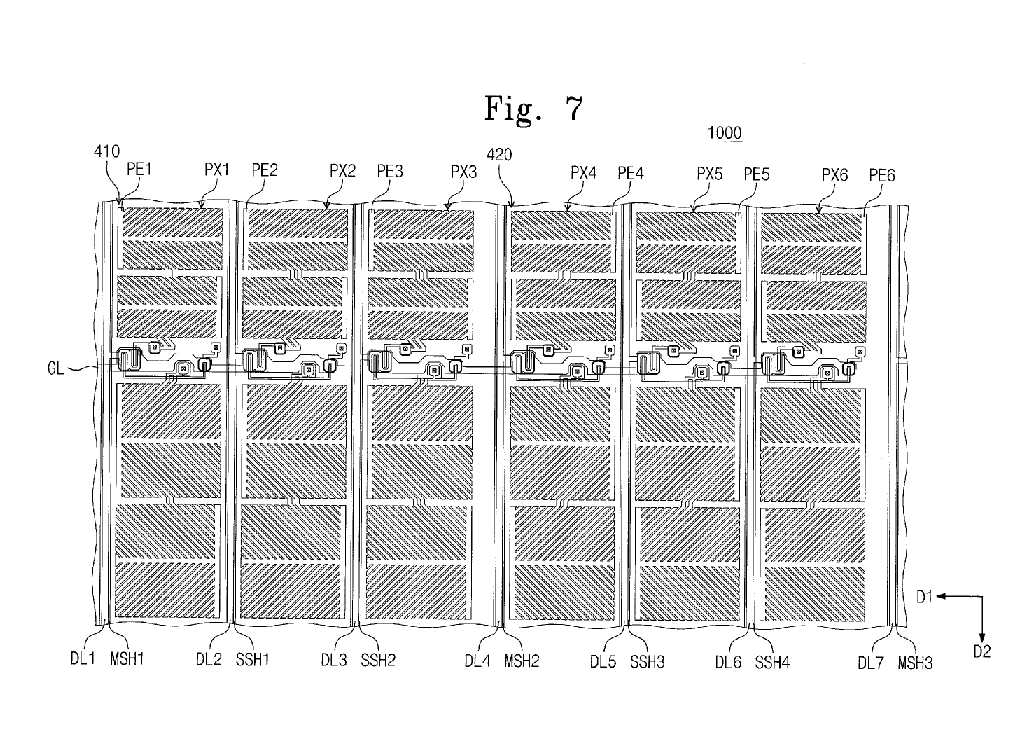

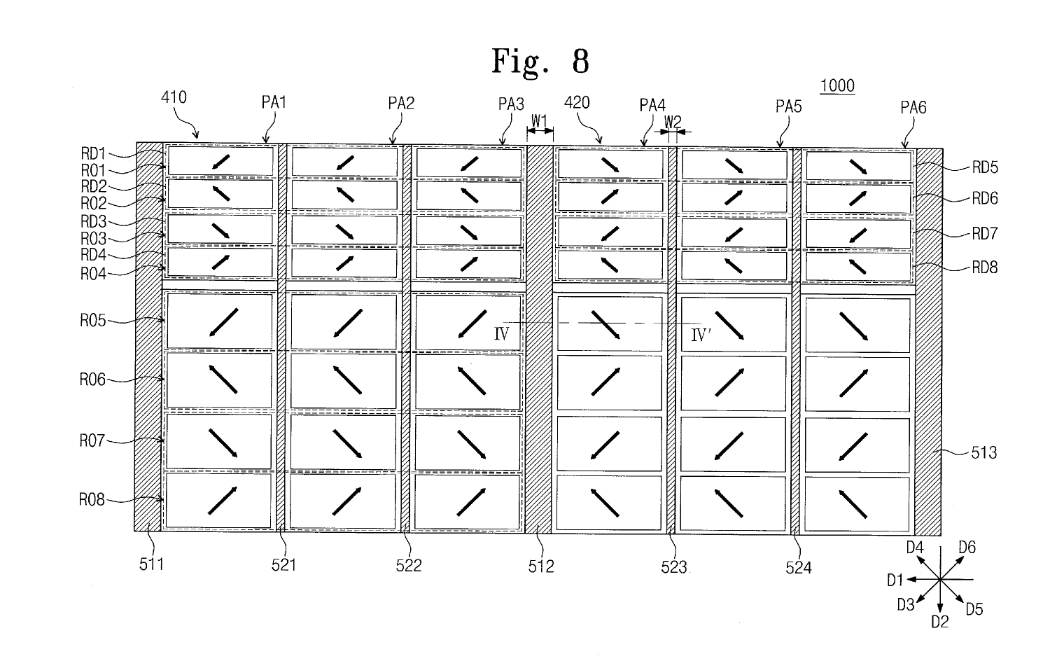

FIG. 7 is a plan view showing first and second dots of the liquid crystal display panel according to an example embodiment of the present disclosure, and FIG. 8 is a plan view showing domains and liquid crystal alignment directions defined in the pixel shown in FIG. 7.

Referring to FIGS. 7 and 8, the liquid crystal display panel 1000 includes first to seventh data lines DL1 to DL7, the gate line GL, a first dot 410, a second dot 420, a first main black matrix area 511, a second main black matrix area 512, a third main black matrix area 513, a first sub-black matrix area 521, a second sub-black matrix area 522, a third sub-black matrix area 523, and a fourth sub-black matrix area 524.

The first dot 410 is arranged along the first direction D1 and includes a first pixel PX1, a second pixel PX2, and a third pixel PX3, which generate the image. The first, second, and third pixels PX1, PX2, and PX3 include a first pixel area PA1, a second pixel area PA2, and a third pixel area PA3, respectively, and each of the first to third pixel area PA1 to PA3 includes a plurality of domains. The domains at the first dot 410 are arranged in a matrix form of n rows by m columns. In the present example embodiment, the domains at the first dot 410 are arranged in a matrix form of eight rows by three columns.

The first to third pixels PX1 to PX3 are sequentially and alternately arranged with the first to third data lines DL1 to DL3 along the first direction D1 and are electrically coupled to (e.g., electrically connected to) the gate line GL.

The first pixel PX1 is electrically coupled to (e.g., electrically connected to) the first data line DL1 to receive a first data signal from the first data line DL1. The second pixel PX2 is electrically coupled to (e.g., electrically connected to) the second data line DL2 to receive a second data signal from the second data line DL2. The third pixel PX3 is electrically coupled to (e.g., electrically connected to) the third data line DL3 to receive a third data signal from the third data line DL3. Accordingly, the pixels PX1, PX2, and PX3 may generate images that are different from each other.

As an example embodiment of the present disclosure, the first to third pixels PX1 to PX3 generate light having colors different from each other. For example, the first pixel PX1 is a red color pixel including a red color filter and generating a red light, the second pixel PX2 is a green color pixel including a green color filter and generating a green light, and the third pixel PX3 is a blue color pixel including a blue color filter and generating a blue light.

The first to third pixels PX1 to PX3 respectively include first, second, and third pixel electrodes PE1, PE2, and PE3 having patterns that define the domains of the first to third pixels PX1 to PX3.

In the present example embodiment, the first to third pixel electrodes PE1 to PE3 have substantially the same or the same pattern. Thus, domains arranged in the same row among the domains of the first dot 410 have the same liquid crystal alignment direction. For example, the liquid crystal alignment direction of a first domain group RD1 disposed in a first row RO1 in the first dot 410 is the third direction D3, the liquid crystal alignment direction of a second domain group RD2 disposed in a second row RO2 in the first dot 410 is the fourth direction D4, the liquid crystal alignment direction of a third domain group RD3 in a third row RO3 in the first dot 410 is the fifth direction D5, and the liquid crystal alignment direction of a fourth domain group RD4 in a fourth row RO4 in the first dot 410 is the sixth direction D6.

Similarly, the liquid crystal alignment directions of the domains arranged in the same row among the domains disposed in fifth to eighth rows RO5 to RO8 are the same, respectively, with each other.

The second dot 420 is arranged along the first direction D1 and includes a fourth pixel PX4, a fifth pixel PX5, and a sixth pixel PX6, which generate the image. The fourth, fifth, and sixth pixels PX4, PX5, and PX6 respectively include fourth, fifth, and sixth pixel areas PA4, PAS, and PA6, and each of the fourth to sixth pixel area PA4 to PA6 includes a plurality of domains DM.

The domains disposed in the second dot 420 are arranged in a matrix form of n rows by m columns. In the present example embodiment, the domains in the second dot 410 are arranged in the matrix form of eight rows by three columns. The fourth to sixth pixels PX4 to PX6 are sequentially and alternately arranged with the fourth to sixth data lines DL4 to DL7 along the first direction D1 and electrically coupled to (e.g., electrically connected to) the gate line GL.

The fourth pixel PX4 is electrically coupled to (e.g., electrically connected to) the fourth data line DL4 to receive a fourth data signal from the fourth data line DL4. The fifth pixel PX5 is electrically coupled to (e.g., electrically connected to) the fifth data line DL5 to receive a fifth data signal from the fifth data line DL5. The sixth pixel PX6 is electrically coupled to (e.g., electrically connected to) the sixth data line DL6 to receive a sixth data signal from the sixth data line DL6. Accordingly, the pixels PX4, PX5, and PX6 may generate images that are different from each other.

As an example embodiment of the present disclosure, the fourth to sixth pixels PX4 to PX6 generate light having colors different from each other. For example, the fourth pixel PX4 is a red color pixel including a red color filter and generating a red light, the fifth pixel PX5 is a green color pixel including a green color filter and generating a green light, and the sixth pixel PX6 is a blue color pixel including a blue color filter and generating a blue light.

The fourth to sixth pixels PX4 to PX6 respectively include fourth, fifth, and sixth pixel electrodes PE4, PES, and PE6 having patterns used to define the domain DM of the fourth to sixth pixels PX4 to PX6.

In the present example embodiment, the fourth to sixth pixel electrodes PE4 to PE6 have substantially the same or the same pattern. Thus, domains arranged in the same row among the domains of the second dot 420 have the same liquid crystal alignment direction. For example, the liquid crystal alignment direction of a fifth domain group RD5 disposed in the first row RO1 in the second dot 420 is the fifth direction D5, the liquid crystal alignment direction of a sixth domain group RD6 disposed in the second row RO2 in the second dot 420 is the sixth direction D6, the liquid crystal alignment direction of a seventh domain group RD7 in the third row RO3 in the second dot 420 is the third direction D3, and the liquid crystal alignment direction of an eighth domain group RD8 in the fourth row RO4 in the second dot 420 is the fourth direction D4.

Similarly, the liquid crystal alignment directions of the domains arranged in the same row among the domains disposed in the fifth to eighth rows RO5 to RO8 are the same, respectively, with each other.

The first to third pixel electrodes PE1 to PE3 disposed in the first dot 410 have the pattern different from the pattern of the fourth to sixth pixel electrodes PE4 to PE6 disposed in the second dot 420. As an example, the pattern of the first to third pixel electrodes PE1 to PE3 is substantially symmetrical to that of the fourth to sixth pixel electrodes PE4 to PE6 with respect to the second direction D2.

The first to third main black matrix areas 511 to 513 extend along the second direction D2 and are alternately arranged with the first and second dots 410 and 420 along the first direction D1. For example, the first dot 410 is disposed between the first main black matrix area 511 and the second main black matrix area 512, and the second dot 420 is disposed between the second main black matrix area 512 and the third main black matrix area 513.

The first and second sub-black matrix areas 521 and 522 extend along the second direction D2 and are alternately arranged with the first to third pixel areas PA1 to PA3 along the first direction D1. For example, the first sub-black matrix area 521 is disposed between the first pixel area PA1 and the second pixel area PA2, and the second sub-black matrix area 522 is disposed between the second pixel area PA1 and the third pixel area PA3.

The third and fourth sub-black matrix areas 523 and 524 extend along the second direction D2 and are alternately arranged with the fourth to sixth pixel areas PA4 to PA6 along the first direction D1. For example, the third sub-black matrix area 523 is disposed between the third pixel area PA3 and the fourth pixel area PA4, and the fourth sub-black matrix area 524 is disposed between the fourth pixel area PA4 and the fifth pixel area PA5.

The liquid crystal display panel 1000 includes a first main shielding electrode MSH1, a second main shielding electrode MSH2, a third main shielding electrode MSH3, a first sub-shielding electrode SSH1, a second sub-shielding electrode SSH2, a third sub-shielding electrode SSH3, and a fourth sub-shielding electrode SSH4.

The first to third main shielding electrodes MSH1 to MSH3 are disposed along the first to third main black matrix areas 511 to 513, respectively. Thus, the first to third main black matrix areas 511 to 513 block the light provided from or emitted by the backlight assembly and traveling toward the first to third main black matrix areas 511 to 513.

The first to fourth sub-shielding electrodes SSH1 to SSH4 are disposed along the first to fourth sub black matrix areas 521 to 524, respectively. Thus, the first to fourth sub-black matrix areas 521 to 524 block the light provided from or emitted by the backlight assembly and traveling toward the first to fourth sub-black matrix areas 521 to 524.

However, they should not be limited thereto or thereby. That is, the first to third main shielding electrodes MSH1 to MSH3 and the first to fourth sub-shielding electrodes SSH1 to SSH4 may be omitted from the main black matrix areas 511 to 513 and the sub-black matrix areas 521 to 524, and a light blocking layer including a light blocking material may be disposed on the main black matrix areas 511 to 513 and the sub-black matrix areas 521 to 524 instead of the shielding electrodes.

A first width W1 along the first direction D1 of the first to third main black matrix areas 511 to 513 is greater than a second width W2 along the first direction D1 of the first to fourth sub-black matrix areas 521 to 524.

In the present example embodiment, the first width W1 is greater than a reference value (e.g., a predetermined reference value), and the second width W2 is smaller than the reference value (e.g., the predetermined reference value). Here, the reference value (e.g., the predetermined reference value) is determined depending on a curvature of the liquid crystal display panel 1000 along the first direction D1 and a thickness of the liquid crystal display panel 1000 when the liquid crystal display panel 1000 is curved along the first direction D1. For instance, the reference value increases as the curvature and thickness of the liquid crystal display panel 1000 become greater. For example, the reference value may be the first length L1 (refer to FIG. 6) described earlier.

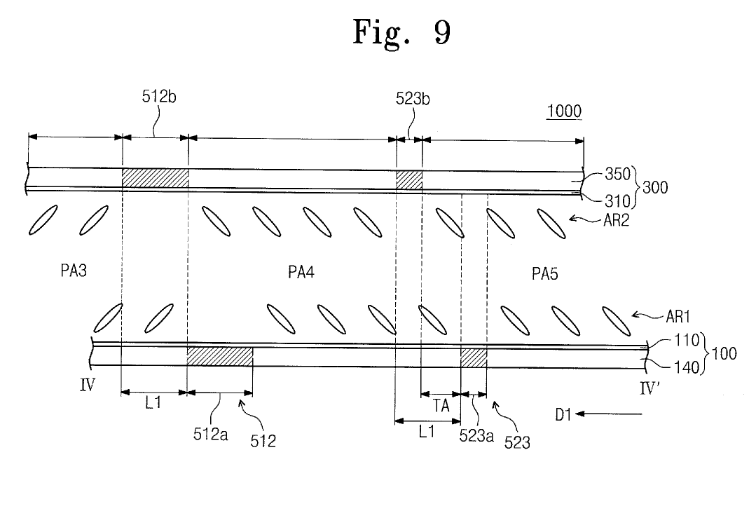

According to the above, the domains disposed in the same row at both sides of the first to third main black matrix areas 511 and 513 have different liquid crystal alignment directions from each other, and the domains disposed in the same row at both sides of the first to fourth sub-black matrix areas 521 to 524 have the same liquid crystal alignment directions. In this case, an aperture ratio of the pixel may be increased by reducing the second width W2 of the first to fourth sub-black matrix areas 521 to 524. Descriptions of the above will be described in more detail with reference to FIG. 9.

FIG. 9 is a cross-sectional view taken along a line IV-IV′ of FIG. 8. For the convenience of explanation, some elements of the liquid crystal display panel 1000 may be omitted from the description of FIG. 9.

Referring to FIG. 9, the opposite substrate 300 includes the second alignment layer 310 and the second base substrate 350, and the array substrate 100 includes the first base substrate 140 and the first alignment layer 110. As described above, the mis-alignment occurs between the array substrate 100 and the opposite substrate 300 because the liquid crystal display panel 1000 is curved along the first direction D1. In this case, the array substrate 100 and the opposite substrate 300 may be misaligned by the first length L1 along the first direction D1.

For example, an area of the array substrate 100 corresponding to the second main black matrix area 512 is referred to as a lower main black matrix area 512a, and an area of the opposite substrate 300 corresponding to the second main black matrix area 512 is referred to as an upper main black matrix area 512b. The lower and upper main black matrix areas 512a and 512b have the first width W1, which is the same as that of the second main black matrix area 512.

Similarly, an area of the array substrate 100 corresponding to the third sub-black matrix area 523 is referred to as a lower sub-black matrix area 523a, and an area of the opposite substrate 300 corresponding to the third sub-black matrix area 523 is referred to as an upper sub-black matrix area 523b. The lower and upper sub-black matrix areas 523a and 523b have the second width W2, which is the same as that of the third sub-black matrix area 523.

In this case, when the mis-alignment occurs between the array substrate 100 and the opposite substrate 300, the upper main black matrix area 512b is misaligned from the lower main black matrix area 512a by the first length L1, and the upper sub-black matrix area 523b is misaligned from the lower sub-black matrix area 523a by the first length L1.

However, because the first width W1 of the first to third main black matrix areas 511 to 513 is greater than the first length L1 and the second width W2 of the first to fourth sub-black matrix areas 521 to 524 is smaller than the first length L1, an alignment defect in each domain DM1 to DM8, which is caused by the mis-alignment, may be prevented.

For example, because the first width W1 is greater than the first length L1, the liquid crystal molecules having different liquid crystal alignment directions from each other are not overlapped in the third and fourth pixel areas PA3 and PA4 even though the mis-alignment occurs and the liquid crystal alignment direction in the third pixel area PA3 is different from that of the fourth pixel area PA4.

In addition, because the liquid crystal alignment direction in the fourth pixel area PA4 is the same as that of the fifth pixel area PA5, the liquid crystal molecules having different liquid crystal alignment directions are not overlapped with each other in the fourth and fifth pixel areas PA4 and PA5 even though the mis-alignment occurs and the second width W2 is smaller than the first length L1.

In a conventional liquid crystal display panel, when the liquid crystal display panel is curved, the liquid crystal molecules in domains aligned along different directions are overlapped with each other due to the mis-alignment between the array substrate 100 and the opposite substrate 300, thereby causing a defect in texture. In addition, when an area for the black matrix is increased between domains to prevent the defect in texture, the aperture ratio of the pixel is decreased.

According to aspects of embodiments of the present disclosure, however, the domains having the same liquid crystal alignment directions are arranged along the first direction D1, that is, the direction the liquid display panel is curved. In addition, the width of the first to fourth sub-black matrix areas 521 to 524 disposed between the domains is reduced, and thus the aperture ratio of the pixels PX1 to PX6 may be increased.

Although example embodiments of the present disclosure have been described herein, it is understood that the present disclosure should not be limited to these example embodiments but various changes and modifications may be made by one ordinary skilled in the art within the spirit and scope of the present disclosure as hereinafter claimed and equivalents thereof.

What is claimed is:

1. A liquid crystal display panel curved along a first direction, the liquid crystal display panel comprising:
an array substrate comprising a first dot comprising a plurality of first pixel areas, a second dot comprising a plurality of second pixel areas, a main black matrix area extending in a second direction crossing the first direction and between the first dot and the second dot, a sub-black matrix area extending in the second direction and between the first pixel areas and the second pixel areas, a plurality of first pixel electrodes, and a plurality of second pixel electrodes;
an opposite substrate facing the array substrate and coupled to the array substrate; and
a liquid crystal layer between the array substrate and the opposite substrate,
wherein each of the first pixel electrodes defines a corresponding first pixel area of the first pixel areas, each of the second pixel electrodes defines a corresponding second pixel area of the second pixel areas, the first pixel electrodes each have a same pattern, the second pixel electrodes each have a same pattern different from that of the first pixel electrodes, and a width of the sub-black matrix area is less than a width of the main black matrix area.

2. The liquid crystal display panel of claim 1, wherein the width of the main black matrix area is greater than a reference value, and the width of the sub-black matrix area is less than the reference value.

3. The liquid crystal display panel of claim 2, wherein the reference value is determined according to a curvature and a thickness of the liquid crystal display panel.

4. The liquid crystal display panel of claim 1, wherein each of the first and second pixel areas comprises a green pixel area configured to display a green light, a red pixel area configured to display a red light, and a blue pixel area configured to display a blue light.

5. The liquid crystal display panel of claim 1, wherein each of the first and second pixel areas comprises a plurality of domains arranged along the second direction, and wherein at least two domains among the domains in each of the first and second pixel areas have liquid crystal alignment directions different from each other.

6. The liquid crystal display panel of claim 5, wherein the domains are arranged in a matrix form comprising n rows by m columns in the first and second dots, the liquid crystal alignment directions of the domains in an n-th row in the first pixel areas are each the same, and the liquid crystal alignment directions of the domains in the n-th row in the second pixel areas are each the same.

7. The liquid crystal display panel of claim 6, wherein the liquid crystal alignment directions of the domains in the n-th row of the first dot are different from the that of the domains in the n-th row of the second dot.

8. The liquid crystal display panel of claim 7, wherein the liquid crystal alignment directions of the domains in the nth row of the first dot are symmetrical to the liquid crystal alignment directions of the domains in the n-th row of the second dot with respect to the main black matrix area.

9. The liquid crystal display panel of claim 5, wherein a portion of each of the first and second pixel electrodes extends to define the domains.

10. The liquid crystal display panel of claim 9, wherein the domains comprise a first domain, a second domain, a third domain, and a fourth domain, which are arranged along the second direction in each of the first and second pixel areas, and each of the first and second pixel electrodes comprises:
first branch portions at the first domain and extending in a direction inclined with respect to the first and second directions in a plan view;
second branch portions at the second domain and extending in a direction inclined with respect to the first and second directions in a plan view;
third branch portions at the third domain and extending in a direction inclined with respect to the first and second directions; and
fourth branch portions at the fourth domain and extending in a direction inclined with respect to the first and second directions.

11. The liquid crystal display panel of claim 5, wherein each of the first and second pixel electrodes comprises a first sub-pixel electrode and a second sub-pixel electrode, and the first and second sub-pixel electrodes are respectively configured to receive different data signals.

12. The liquid crystal display panel of claim 1, wherein the array substrate further comprises a shielding electrode electrically insulated from the pixel electrode and arranged along the main and sub-black matrix areas, and wherein the shielding electrode is configured to control the liquid crystal layer to display a gray scale.

13. The liquid crystal display panel of claim 12, wherein the opposite substrate comprises a common electrode, and wherein the shielding electrode is configured to receive a voltage having a same voltage level as the voltage applied to the common electrode.

14. The liquid crystal display panel of claim 13, wherein the array substrate further comprises an insulating layer between the pixel electrode and the shielding electrode.

15. The liquid crystal display panel of claim 1, wherein the liquid crystal layer comprises liquid crystal molecules having a negative dielectric anisotropy.

16. The liquid crystal display panel of claim 1, wherein the array substrate further comprises a plurality of data lines extending in the second direction and a plurality of gate lines extending in the first direction, and wherein the data lines are arranged along the main and sub-black matrix areas.

17. The liquid crystal display panel of claim 16, further comprising a light blocking layer extending along the gate lines, covering the gate lines in a plan view, and comprising a light blocking material.

18. The liquid crystal display panel of claim 16, further comprising a light blocking layer extending along the main and sub-black matrix areas, covering the main and sub-black matrix areas in a plan view, and comprising a light blocking material.
